(19) United States
(12) Patent Application Publication
(10) Pub. No.: US 2026/0151209 A1
(43) Pub. Date: Jun. 4, 2026

(54) SEQUENTIAL STACKABLE SURGICAL GUIDE SYSTEM AND METHOD

(71) Applicant: 3D Diagnostix, Inc., Boston, MA (US)

(72) Inventor: Khaled ElSaid, Cairo (EG)

(21) Appl. No.: 19/409,520

(22) Filed: Dec. 4, 2025

Related U.S. Application Data
(60) Provisional application No. 63/728,023, filed on Dec. 4, 2024.

(51) Int. Cl. A61C 1/08; A61C 8/00; A61C 13/00

(52) U.S. Cl. CPC A61C 1/084; A61C 8/0089; A61C 8/0095; A61C 13/0019

(57) ABSTRACT

A novel method and system are provided for a base guide with a retention mechanism designed to facilitate sequential dental implant surgical guides and immediate loading of a fixed full-arch provisional prosthesis. The system leverages advanced computer-guided surgery technology to enhance accuracy, efficiency, and patient outcomes in implant dentistry. The base guide with retention mechanism serves as a foundational component for guiding the sequential placement of dental implants and facilitating immediate loading of a fixed full-arch provisional prosthesis, offering significant benefits to clinicians and patients alike. A pin positioning guide that latches over the cusps of a small number of teeth is used to place the base guide.

This application claims the benefit of priority to U.S. Provisional Patent Application No. 63/728,023, filed on Dec. 4, 2024, which is herein incorporated by reference in its entirety.

### BACKGROUND

Full arch-rehabilitation via dental implant surgery plays a crucial role in restoring oral function and aesthetics for patients with missing teeth and/or end-stage dentition. The procedure typically involves multiple steps, including pre-surgical planning, guide fabrication, implant placement, and prosthesis attachment. Immediate loading of a full-arch provisional prosthesis offers numerous advantages, including improved patient satisfaction and a significantly reduced treatment course. However, the available systems often lack the efficiency and precision required for such complex procedures.

### SUMMARY AND ADVANTAGES

A removable pin positioning guide (PPG) is combined with a base (bone reduction) guide (BRG) and is used to place the BRG into the mouth of the patient for precise attachment to the bone. In one aspect, a teeth-borne PPG is designed with minimal support legs that extend vertically and latch over the cusps of one or more teeth, resulting advantageously in less bulk of material and thus better visibility of the bound working space, as well as cost-effectiveness over full coverage alternatives. The minimal PPG support legs facilitate the insertion of the combination PPG/BRG.

In another aspect, a bone-borne PPG is designed for cases where the ridge is either fully edentulous and the patient does not have a reliable denture to use for dual scanning, or where the teeth model (STL) would be of suboptimal quality or non-reliably matching to the CBCT scans. The bone-borne PPG may also be designed with inspection windows and an overall low profile of bulkiness to facilitate its insertion into the patient's mouth along with the BRG.

In another aspect, a hybrid tooth/bone-borne PPG is designed for cases where the ridge is partially edentulous. The tooth/bone-borne PPG includes support legs to extend vertically and over the cusps of one or more teeth, as well as one or more supports that rest on or engage with exposed edentulous portions of the ridge.

In another aspect, a denture-like bone supported PPG is designed to offer dual stabilization, having its intaglio surface sitting on the existing bone anatomy as a solid structure, while the occlusal surface mimics the denture teeth to allow for indexing to the opposing arch denture/dentition.

The BRG is preferably designed with definite distal ends to outline the bound working space. The distal end can be designed to be supported on existing bone anatomy, available tooth/teeth, or a mixture of both depending on the case situation. When designed without a lingual support, the BRG requires less flap elevation (essentially on the facial aspect and extending distal to the bound working space) to be fully seated, thus improving the ease of use overall for clinicians. Furthermore, the lesser need for flap elevation aids to reduce tissue morbidity and patient discomfort post-operatively, which is otherwise common in such procedures. The BRG is also preferably designed with a minimal offset space from the facial bone surface, to accommodate any discrepancies during virtual bone segmentation, guide manufacturing, or clinical usage.

The full solution is preferably manufactured using standard 3D printed resin material. Such resin or polymers are readily available, and thus are more cost-effective while offering proper integrity and strength to prevent breakage when adequately used. The use of 3D printing is further advantageous because it requires less post-processing, is lighter in weight, and offers increased visibility of the supporting structures.

Magnets are preferably used as an attachment/retention mechanism to secure the BRG to the PPG and subsequent surgical guides. The novel use of magnets in this arrangement provides the added benefit of eliminating the use of any external removable parts for locking, which frequently is accompanied by risks of imprecise alignment, lost parts, dropped parts outside the mouth, or more significantly inside the mouth as they have the potential to be swallowed being small in size. The use of magnetic stackable guides also reduces the time required for finishing the procedure when compared to the time for the same procedure with external attachments or retention mechanisms. Nevertheless, the invention is not limited to using magnets as an attachment mechanism, and other attachment mechanisms are contemplated as within the scope of the invention.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1A is an anterior view of a Denture-Like bone-supported PPG stacked on a BRG and occluding with the antagonist denture, in accordance with an embodiment of the invention.

FIG. 1B is an occlusal view of a Denture-Like bone-supported PPG stacked on a BRG, in accordance with an embodiment of the invention.

FIG. 1C is an anterior view of a Denture-Like bone-supported PPG by itself, in accordance with an embodiment of the invention.

FIG. 1D: is an Intaglio view of a Denture-Like bone-supported PPG, in accordance with an embodiment of the invention.

FIG. 1E is an occlusal view of a BRG seated on existing bone anatomy, in accordance with an embodiment of the invention.

FIG. 2A is an Intaglio view of a Bone-supported PPG, in accordance with an embodiment of the invention.

FIG. 2B is an anterior view of a Bone-supported PPG stacked on a BRG, in accordance with an embodiment of the invention.

FIG. 2C is an anterior view of a Bone-supported PPG by itself, in accordance with an embodiment of the invention.

FIG. 3A is an anterior view of a Teeth-supported PPG showing legs that latch over cusps of teeth, stacked on a BRG and seated on the existing teeth after flap reflection, in accordance with an embodiment of the invention.

FIG. 3B is an anterior view of a BRG while the teeth are still present, in accordance with an embodiment of the invention.

FIG. 3C is an anterior view of a BRG after teeth extraction and before bone reduction, in accordance with an embodiment of the invention.

FIG. 3D is an anterior view of a BRG after guided bone reduction, in accordance with an embodiment of the invention.

FIG. 3E is an occlusal view of a BRG seated on existing bone anatomy after guided bone reduction, in accordance with an embodiment of the invention.

FIG. 3F is an anterior view of an implant surgical guide stacked on a BRG after guided bone reduction, in accordance with an embodiment of the invention.

FIG. 3G is an anterior view of a stackable full-arch prosthesis stacked on a BRG, in accordance with an embodiment of the invention.

FIG. 3H is an occlusal view of the stackable full-arch prosthesis, including pickup holes, stacked on a BRG, in accordance with an embodiment of the invention.

FIG. 4A is an Intaglio view of a Teeth/bone-supported PPG, in accordance with an embodiment of the invention.

FIG. 4B is an anterior view of a Teeth/bone supported PPG showing legs that latch over the teeth/bone, and stacked on a BRG, in accordance with an embodiment of the invention.

FIG. 4C is an occlusal view of a Teeth/bone-supported PPG showing legs that latch over the teeth/bone, and stacked on a BRG, in accordance with an embodiment of the invention.

FIG. 4D is an occlusal view of a BRG without a teeth/bone-supported PPG while the teeth are still present, in accordance with an embodiment of the invention.

FIG. 4E is an occlusal view of a BRG seated on existing bone anatomy after selective teeth extraction and guided bone reduction, in accordance with an embodiment of the invention.

### DETAILED DESCRIPTION

An embodiment of the proposed method and system comprises a base guide serving as a stable platform for guiding the sequential drilling and placement of dental implants and supporting the immediate loading of a full-arch provisional prosthesis. The base guide is precisely positioned and affixed to the bone anatomy of a patient's mouth as described below. The base guide may also preferably contain a substantially flat surface to be used for bone reduction.

A retention mechanism securely holds the sequential surgical guides in place, each guide attaching in sequence to the base guide, ensuring precise alignment and stability during implant placement.

A removable teeth-borne or bone-borne or teeth/bone-borne pin positioning guide (PPG) has an adaptation surface to fit onto the patient's oral dental anatomy as well as indexing and retention features that lock it into the base (bone reduction) guide (BRG). The retention features could be magnets, mechanical locking mechanisms and/or other suitable attachment mechanisms as known in the field.

The detachable PPG is advantageously designed with legs/latches that sit/latch on the teeth/bone/teeth & bone of the arch of interest. Some embodiments use the opposing arch for positioning and stabilization. The legs/latches of the PPG need not surround all of the teeth, or even a portion of the teeth. Rather, the legs/latches of the PPG preferably engage sufficiently with the cusps of a sufficient number of teeth so as to ensure stability. In this manner, no tooth is thus fully enclosed by the PPG, which enables ease of maneuverability in placement and the removal of the PPG.

The base (bone reduction) guide preferably extends on the labial portion of the mandibular arch, arches upwards and extends horizontally to rest on the distal crestal bone and/or tooth/teeth. Some embodiments extend still further, to the lingual side of the arch.

For a maxillary case, the bone reduction guide preferably extends on the labial portion of the maxillary arch, arches downwards and extends horizontally to rest on the distal crestal bone and/or tooth/teeth. Some embodiments extend still further, to the lingual (palatal) side of the arch.

In some embodiments, the base (bone reduction) guide is designed with distal ends that wrap around the ridge labially and orally or labially only with an arching distal end. The extents of the different parts of the BRG create a bounding box for the surgical area. The surgical area can involve bone reduction, augmentation, or other procedures.

The combination of the removable pin positioning guide and the base (bone reduction) guide is used after full arch full-thickness flap reflection, where the gum tissue is released from the underlying bone to expose the bone. This provides for optimum visualization and subsequent tooling to allow for drilling fixation pins/anchor screws through the base guide in the pre-planned positions. The fixation pins/anchor screws stabilize the base (bone reduction) guide into bone. The pins/screws need only be removed at the end of the procedure along with the base (bone reduction) guide.

Once fixed, the pin positioning guide part is detached and removed, allowing all remaining guides and prostheses to share the same reference base (bone reduction) guide platform.

The base (bone reduction) guide and fixation pins remain throughout the procedure and each sequential part in the series has a predefined position through indexing geometric features like slots for pegs/arms, and is retained using magnets, mechanical locking mechanisms and/or others known in the field.

Embodiments of the invention include but are not limited to the following:

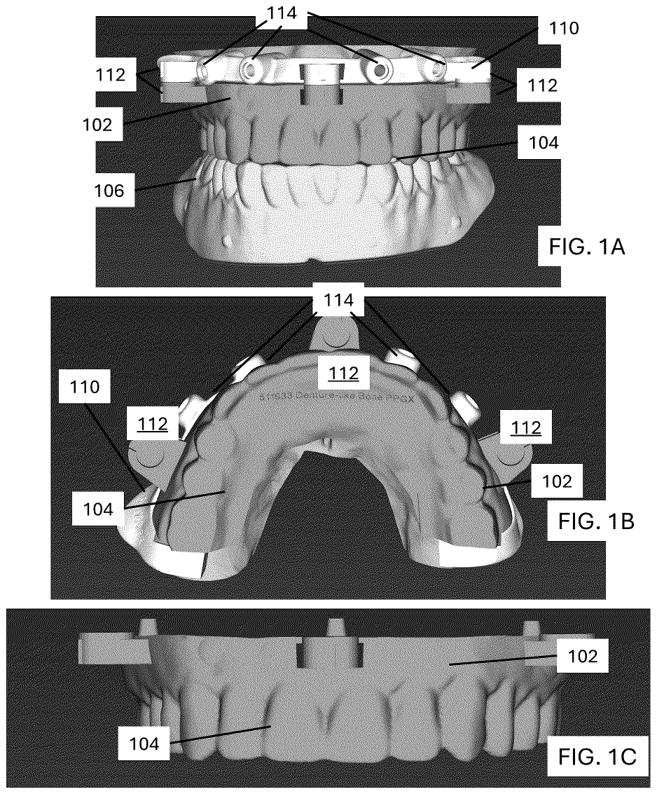

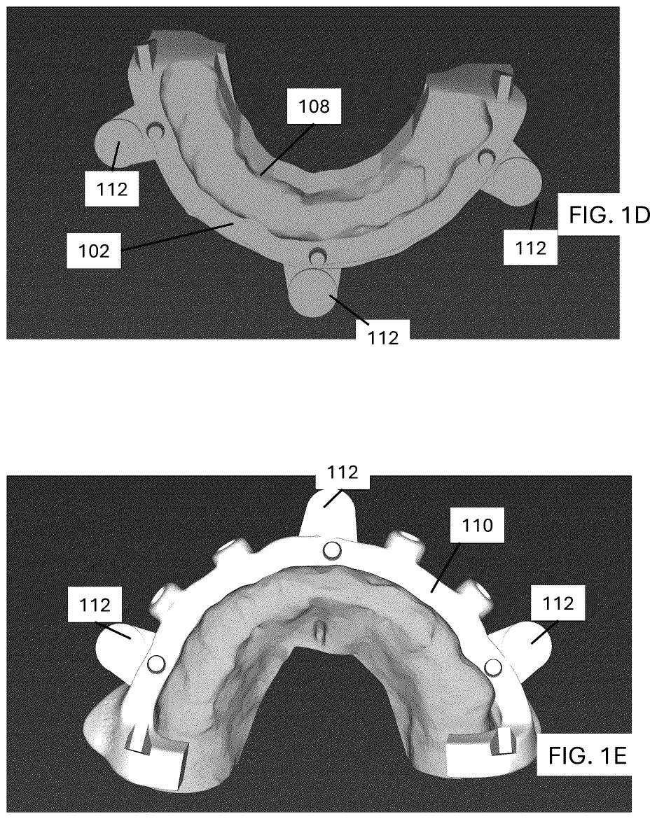

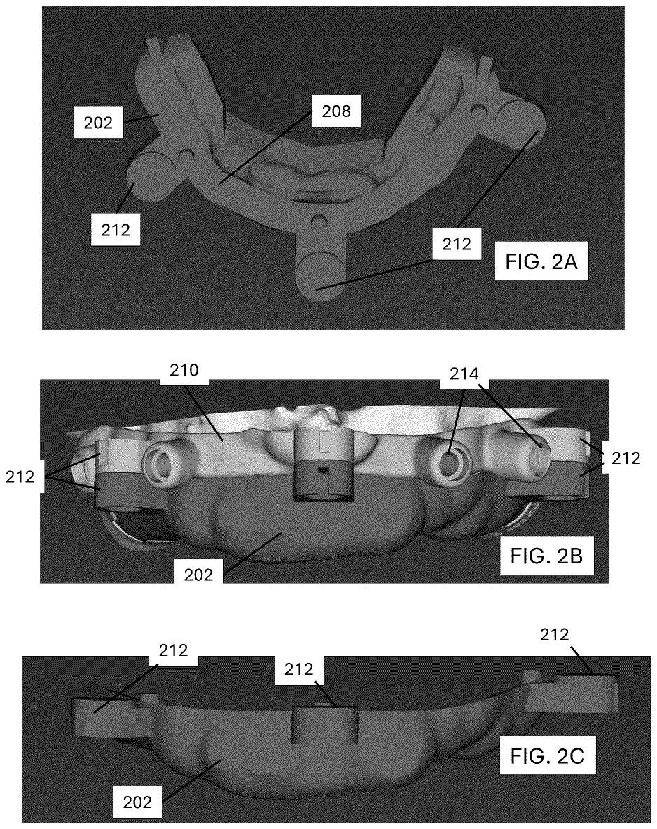

With reference to FIGS. 1A-1E, one embodiment may be used when the patient's dental ridge is fully edentulous. In such a case, it is ideal to acquire a dual scan technique involving one scan of the patient wearing the removable denture and another of the denture by itself, using radiographic markers adhering to the outer surface of the denture to serve as a matching reference within the planning software to proceed with a prosthetically-driven implant planning.

In this case, the removable pin positioning guide 102 may be designed with an outer shell 104 that mimics the denture to occlude with the opposing ridge dentition/denture 106 for accurate positioning and stabilization during the drilling of the fixation osteotomies. The inner fitting surface 108 of the PPG is fitted to the patient's existing bone anatomy as it is 3D segmented from the pre-operative CBCT scan.

The base (bone reduction) guide (BRG) 110 is preferably designed to fit on the patient's ridge after releasing the gum tissue (flap reflection) at the respective operatory area. The BRG attaches to the PPG 102 via a suitable attachment mechanism, such as a set of magnets 112. In combination with the PPG 102, the placed BRG 110 is used to drill fixation osteotomies in situ before placing the fixation pins/anchor screws in the BRG 110 through positioning holes 114. In this manner, the BRG 110 is preferably secured for the rest of the procedure. The removable PPG 102 is removed after fixation indexing of the base guide 110 to allow for the subsequent steps of alveolar ridge reduction and/or re-building.

Referring to FIGS. 2A-2C, another embodiment may be used for a fully edentulous patient, through the use of a bone-borne pin positioning guide 202. As with the denture mimicking PPG described in the embodiment above, the inner fitting surface 208 of the bone-borne PPG is fitted to the patient's existing bone anatomy as it is 3D segmented from the pre-operative CBCT scan. The BRG 210 and PPG 202 otherwise operated identically as described above, with a set of magnets 212 or other attachment mechanism used to secure the BRG 210 and PPG 202, and positioning holes 214 in the BRG 210 through which fixation osteomoties are drilled and pins/anchor screws are place to fix the BRG 210 to the bone of the patient.

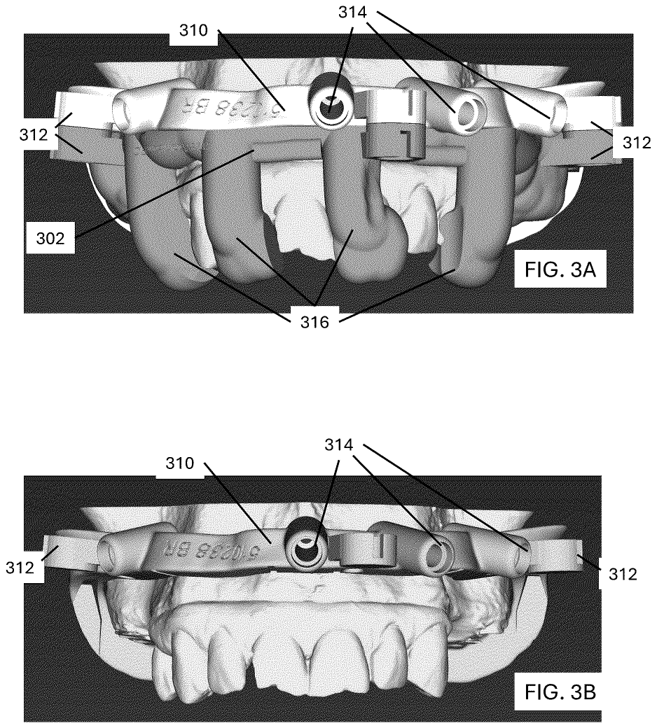

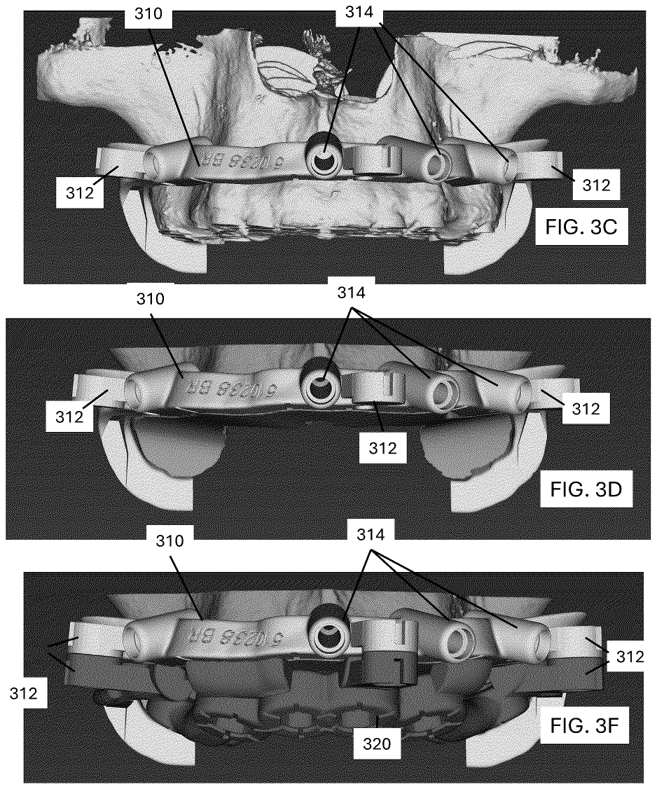

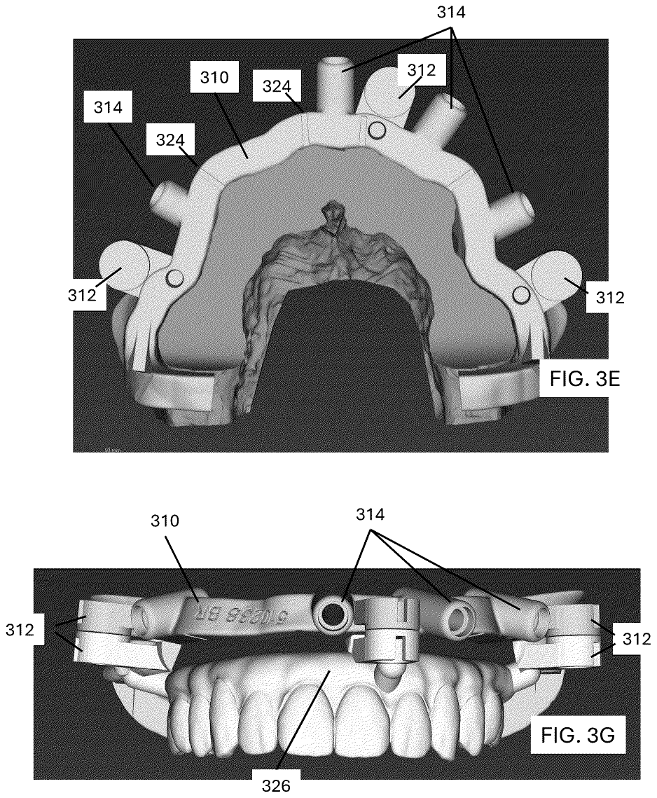

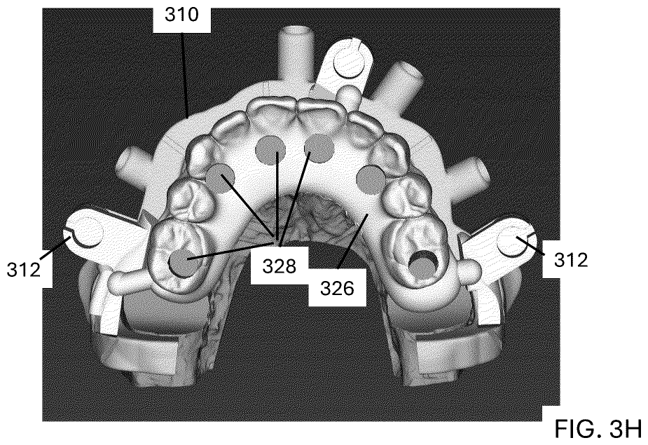

Referring to FIGS. 3A-3H, a teeth-borne base (bone reduction) guide (BRG) 302 is described in accordance with another embodiment. For a sufficiently dentate patient, the BRG 302 preferably includes legs or latches 316 that extend generally vertically in relation to the remainder of the BRG. The legs/latches 316 are designed to sit on and/or latch with teeth of the arch of interest. The legs/latches 316 of the PPG 302 need not surround all of the teeth, or even a portion of the teeth. Rather, the legs/latches 316 of the PPG 302 preferably engage sufficiently with the cusps of a sufficient number of teeth so as to ensure stability. In some cases, a single leg/latch may engage with multiple adjacent teeth. A leg/latch may also engage with a tooth or teeth on the opposing ridge, for increased stability.

As in the previously described embodiments, the teeth-borne PPG 302 attaches to BRG 310 via an attachment mechanism, such as magnets 312. After properly positioning the BRG 310 using the attached PPG 302 as registered with the patient's teeth, the BRG 310 is affixed to the patient's bone with pins or screws through PPG holes 314, and the PPG 302 is then removed, as shown in FIG. 3B. Remaining teeth may then be extracted, as shown in FIG. 3C. The BRG 312 may then be used to guide bone reduction, as shown in FIG. 3D and FIG. 3E.

After the alveolar ridge is cut down and/or rebuilt, an implant surgical guide (ISG) 320 can be then attached to the BRG 310, using magnets 312 or other attachment mechanism, to allow for sequential drilling and implant placement in situ as pre-planned, as shown in FIG. 3F. The ISG 320 preferably has pre-defined implant timing grooved indicators which allow the clinician to position the implant with the proper pre-planned rotation for it to receive the (angled) prosthetic components which aid in the pickup procedure of the immediate provisional full-arch prosthesis. The (angled) prosthetic components are preferably indexed via timing indicators 324 that are grooved (and colored) on the base (bone reduction) guide 310 itself.

After the ISG 320 has been used to drill for proper placement of implants, it is removed from the BRG 310. An immediate provisional prosthesis 326 may then be placed on the BRG 310, again using magnets 312 or another attachment mechanism, as shown in FIG. 3G and FIG. 3H. The prosthesis 326 is designed with pickup holes 328 matching the pre-planned emergence of the prosthetic components to facilitate intraoral pickup before the removal of the combination of prosthesis and picked-up restorative components altogether so that they are adequately finished chairside. Meanwhile, the clinician may continue the surgical procedure of bone trimming/building and suture the gum tissue back over healing caps on respective implants to avoid the collapse of soft tissue over the implants'trajectories. After the restoration is finished chairside, the prosthesis 326 may be re-introduced to the patient's mouth to be fixed using implants prosthetic screws and followed by intraoral occlusal equilibration eventually.

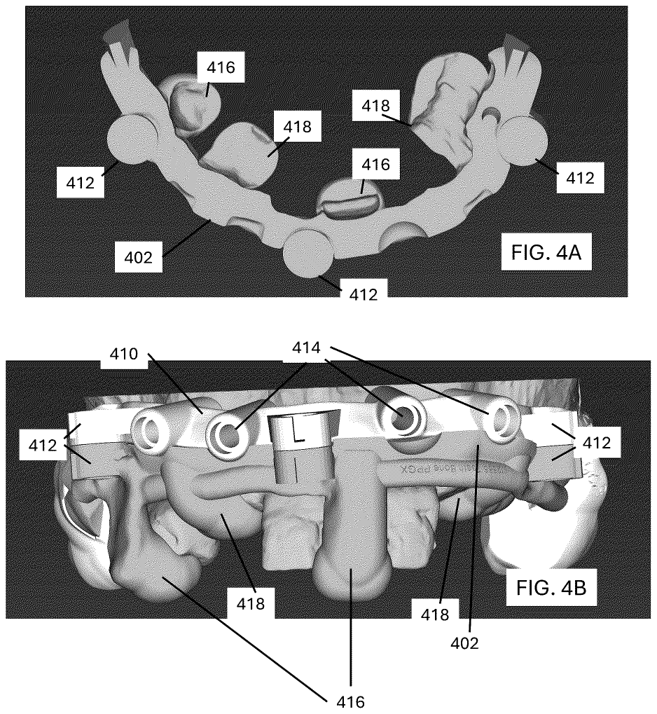

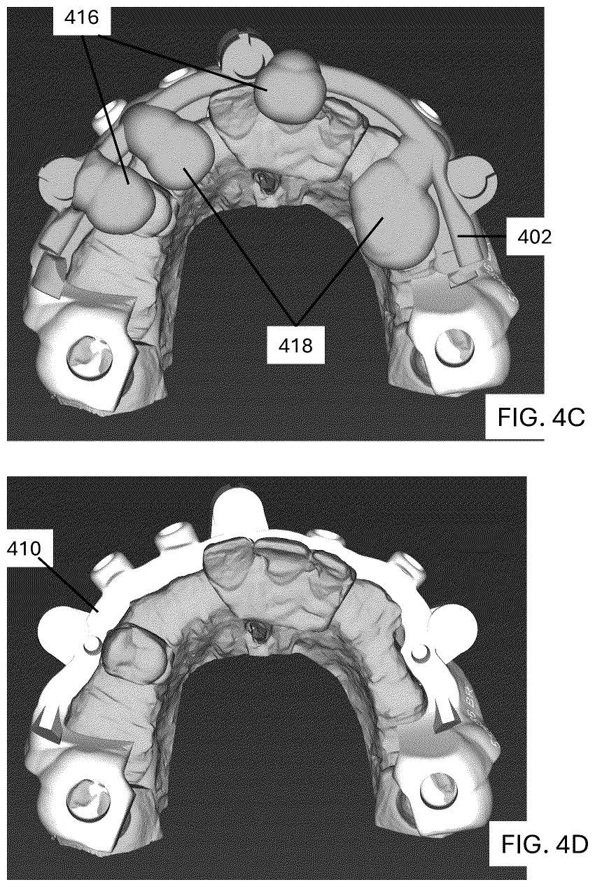

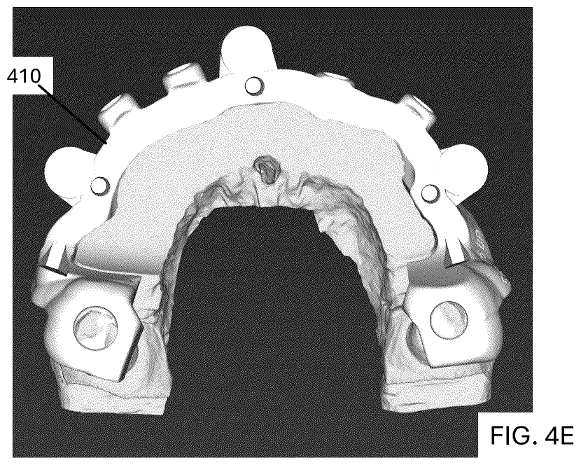

While the previously described embodiment employs a PPG with legs/latches that engage cuspally with a patient's teeth, another embodiment comprises a combination teeth/bone-borne base (bone reduction) guide 402, where some teeth may be kept as a foundation while portions of the patient's alveolar ridge bone are also used to stabilize the guide. Vertically directed legs/latches 416 extend from the PPG 402 in the manner described above, while inwardly directed legs/latches 418 latch or rest on exposed edentulous portions of the ridge, as seen in FIGS. 4A-4C. The use of a teeth/bone-borne PPG may depend on but is not limited to the pre-planned open space of the BRG as preplanned virtually on the software. As described above, once the BRG 410 has been properly positioned and affixed to the patient's bone with pins or screws through holes 414, the PPG is removed, as seen in FIG. 4D. Remaining teeth may then be extracted and bone reduced using the BRG 410, as described above and as seen in FIG. 4E.

The above description sets a broad summary of one or more embodiments of the invention so that the detailed description that follows may be better comprehended and the significant contribution of the invention may be better appreciated. There are additional features of the invention that will be further detailed in the following illustrations and descriptions, which may form the basis of the subject matter of claims.

The invention is not limited in its application to the details of the construction and arrangement of the components outlined in the following illustrations and descriptions. It is capable of being used in other embodiments in various ways.

Also, it is to be noted that the phraseology and terminology employed here are for description and should not be considered as limiting.

1. A system of stackable sequential surgical guides for installing a full-arch provisional prosthesis in a patient, comprising:
a pin positioning guide; and
a base guide comprising a plurality of holes configured to receive pins for attaching the base guide to the bone of the patient's mouth at pre-planned positions;
the pin positioning guide removably attached to the base guide and comprising one or more legs configured to engage with the cusps of one or more teeth.

2. The system of claim 1, wherein each of the one or more legs of the pin positioning guide does not completely enclose any tooth.

3. The system of claim 2, wherein each of the one or more legs of the pin positioning guide extends vertically along the facial wall of a tooth and over an incisal, mesial or occlusal cusp of the tooth.

4. The system of claim 1, wherein the base guide and pin positioning guide comprise complementary sets of magnets for attaching the guides together.

5. The system of claim 1, wherein the base guide is made from a traditional plastic or resin material through a 3D printing process.

6. The system of claim 1, wherein the base guide includes a projection at one or both of its distal ends, extending laterally from the buccal side toward the lingual side, for seating on the distal crestal bone.

7. The system of claim 1, further comprising an implant surgical guide for removable attachment to the base guide and configured with pre-defined timing grooved indicators for facilitation of drilling holes for implant placement.

8. The system of claim 1, wherein the patient is partially edentulous and the pin positioning guide further comprises one or more legs configured to extend inwardly and rest over the bone of the patient.

9. A method for installing a full-arch provisional prosthesis in a patient, comprising:
providing a base guide comprising a plurality of holes configured to receive pins for attaching the base guide to the bone of the patient's mouth at pre-planned positions;
providing a pin positioning guide that removably attaches to the base guide and includes one or more legs configured to engage with the cusps of one or more teeth;
attaching the base guide to the pin guide;
utilizing the attached pin positioning guide to place the base guide in the patient's mouth;
securing the base guide to the bone of the patient's mouth at the pre-planned positions; and
removing the pin positioning guide from the base guide.

10. The method of claim 9, wherein each of the one or more legs of the pin positioning guide does not completely enclose any tooth.

11. The method of claim 10, wherein each of the one or more legs of the pin positioning guide extends vertically along the facial wall of a tooth and over an incisal, mesial or occlusal cusp of the tooth.

12. The method of claim 10, wherein the base guide and pin positioning guide comprise complementary sets of magnets for attaching the guides together.

13. The method of claim 10, wherein the base guide is made from a traditional plastic or resin material through a 3D printing process.

14. The method of claim 10, wherein the base guide includes a projection at one or both of its distal ends, extending laterally from the buccal side toward the lingual side, for seating on the distal crestal bone.

15. The method of claim 10, further comprising:
using the base guide to cut down the alveolar ridge in a bone reduction procedure.

16. The method of claim 15 further comprising:
providing an implant surgical guide for removable attachment to the base guide and configured with pre-defined timing grooved indicators for facilitation of drilling holes for implant placement;
attaching the implant surgical guide to the base guide;
drilling implant placement holes using the attached implant surgical guide.

17. The method of claim 9, wherein the patient is partially edentulous and the pin positioning guide further includes one or more legs configured to extend inwardly and rest over the bone of the patient.
